(19) United States
(12) Patent Application Publication
(10) Pub. No.: US 2026/0036724 A1
(43) Pub. Date: Feb. 5, 2026

(54) VISUAL SYSTEM

(71) Applicant: Zhejiang Sunny Optics Co., Ltd, Yuyao City (CN)

(72) Inventors: Bukang Zhang, Yuyao City (CN); Huan Liu, Yuyao City (CN); Jinxing You, Yuyao City (CN); Xiaobin Zhang, Yuyao City (CN)

(21) Appl. No.: 18/979,549

(22) Filed: Dec. 12, 2024

(30) Foreign Application Priority Data
Aug. 2, 2024 (CN) 202411061964.7

(51) Int. Cl. G02B 3/00; G02B 5/30; G02B 7/02; G02B 27/01

(52) U.S. Cl. CPC G02B 3/0043; G02B 5/3025; G02B 7/021; G02B 27/0172; G02B 2003/0093

(57) ABSTRACT

A visual system includes a lens barrel, and a lens group and a spacing element group. The lens group includes, arranged in sequence: a first lens having a positive refractive power, a reflective polarizing element, a first quarter wave plate, a second lens having a negative refractive power, a third lens having a refractive power, a partially reflective element, a second quarter wave plate, a polarizer, and a fourth lens having a refractive power. A spacing EP01 from a first side surface of the lens barrel to a first side surface of the first spacing element along the optical axis and a center thickness CT1 of the first lens on the optical axis satisfy: 1.0<EP01/CT1<1.7; and an inner diameter dos of the first side surface of the lens barrel and a radius of curvature R1 of a first side surface of the first lens satisfy: 1.75<d0s/R1<2.3.

### CROSS-REFERENCE TO RELATED APPLICATIONS

This application claims the priority from Chinese Patent Application No. 202411061964.7, filed in the National Intellectual Property Administration (CNIPA) on Aug. 2, 2024, the contents of which are hereby incorporated by reference in their entirety.

### TECHNICAL FIELD

The present disclosure relates to the field of optical devices, in particular, to a visual system.

### BACKGROUND

Currently, more and more optical lens assemblies are being applied to various apparatuses in virtual reality technology. MR (Mixed Reality) technology is a combination of VR (Virtual Reality) and AR (Augmented Reality), which superimposes virtual content in the real world, allowing users to interact between the real world and a virtual world. Nowadays, MR technology has been widely applied in industries such as training and education, healthcare, industrial manufacturing, and architectural design.

As the technology continues to advance, head-mounted display devices and hardware of virtual reality apparatuses will continue to improve, becoming lighter, smaller, more comfortable, and more powerful. The integration of various sensors, displays, and computing units in the virtual reality apparatuses may provide a higher quality and smoother experience for users.

Considering the above development status of the virtual reality apparatuses, how to further improve a projection capability of the displays of the head-mounted devices, so as to enhance the sense of immersion, and further improve the users' sense of experience has always been a continuous pursuit in this field.

### SUMMARY

Embodiments of the present disclosure provides a visual system that may at least solve, or partially solve, at least one problem or other problems present in existing technology.

A first aspect of the present disclosure provides a visual system, which may include a lens barrel, and a lens group and a spacing element group assembled within the lens barrel, where, the lens group includes, arranged in sequence along an optical axis from a first side to a second side: a first lens having a positive refractive power, a reflective polarizing element, a first quarter wave plate, a second lens having a negative refractive power, a third lens having a refractive power, a partially reflective element, a second quarter wave plate, a polarizer, and a fourth lens having a refractive power; the spacing element group includes: a first spacing element disposed between the first lens and the second lens and against a second side surface of the first lens, a second spacing element disposed between the second lens and the third lens and against a second side surface of the second lens, and a third spacing element disposed between the third lens and the fourth lens and against a second side surface of the third lens; where, the number of lenses having refractive powers in the lens group is four; a spacing EP01 from a first side surface of the lens barrel to a first side surface of the first spacing element along the optical axis and a center thickness CT1 of the first lens on the optical axis satisfy: 1.0<EP01/CT1<1.7; and an inner diameter dos of the first side surface of the lens barrel and a radius of curvature R1 of a first side surface of the first lens satisfy: 1.75<d0s/R1<2.3.

According to an implementation of the present disclosure, a spacing EP12 from a second side surface of the first spacing element to a first side surface of the second spacing element along the optical axis, a center thickness CT2 of the second lens on the optical axis, and an axial distance T23 from the second side surface of the second lens to a first side surface of the third lens satisfy: 0.2<EP12/(CT2+T23)<1.2.

According to an implementation of the present disclosure, an outer diameter D1m of a second side surface of the first spacing element and an outer diameter D2m of a second side surface of the second spacing element satisfy: 1.0<D1m/D2m<1.2.

According to an implementation of the present disclosure, an inner diameter d2s of a first side surface of the second spacing element, an inner diameter d2m of a second side surface of the second spacing element, a radius of curvature R4 of the second side surface of the second lens, and a radius of curvature R5 of a first side surface of the third lens satisfy: 0.2<(d2s+d2m)/(R4+R5)<0.65.

According to an implementation of the present disclosure, an inner diameter d3s of a first side surface of the third spacing element and a center thickness CT3 of the third lens on the optical axis satisfy: 2.0<d3s/CT3<2.95.

According to an implementation of the present disclosure, an inner diameter d0m of a second side surface of the lens barrel, a center thickness CTQ2 of the second quarter wave plate on the optical axis, a center thickness CTL of the polarizer on the optical axis, and a center thickness CT4 of the fourth lens on the optical axis satisfy: 6.2<d0m/(CTQ2+CTL+CT4)<9.9.

According to an implementation of the present disclosure, an inner diameter d1m of a second side surface of the first spacing element, and a combined focal length fz1 of the reflective polarizing element, the first quarter wave plate and the second lens, satisfy: −0.65<d1m/fz1<−0.05.

According to an implementation of the present disclosure, an inner diameter d3m of a second side surface of the third spacing element, an outer diameter D3m of the second side surface of the third spacing element, and a combined focal length fz2 of the second quarter wave plate, the polarizer and the fourth lens satisfy: 0.2<(d3m+D3m)/|fz2|<1.0.

According to an implementation of the present disclosure, an outer diameter D3s of a first side surface of the third spacing element and a radius of curvature R6 of the second side surface of the third lens satisfy: −0.3<D3s/R6<0.

According to an implementation of the present disclosure, an outer diameter D0s of the first side surface of the lens barrel, an outer diameter D0m of a second side surface of the lens barrel, and a spacing L from the first side surface of the lens barrel to the second side surface of the lens barrel along the optical axis satisfy: 0.15<(D0s−D0m)/L<0.55.

According to an implementation of the present disclosure, a maximal thickness CP2 of the second spacing element, a spacing EP23 from the second side surface of the second spacing element to the first side surface of the third spacing element along the optical axis, the center thickness CT3 of the third lens on the optical axis, and an axial distance T34 from the second side surface of the third lens to a first side surface of the fourth lens satisfy: 0.8<(CP2+EP23)/(CT3+T34)<2.2.

According to an implementation of the present disclosure, an outer diameter D2s of the first side surface of the second spacing element and an effective focal length f2 of the second lens satisfy: −0.85<D2s/f2<−0.1.

According to an implementation of the present disclosure, a maximal thickness CP1 of the first spacing element and a maximal thickness CP3 of the third spacing element satisfy: 0.4<CP1/CP3<1.05.

According to an implementation of the present disclosure, an inner diameter d1s of the first side surface of the first spacing element, an outer diameter D1s of the first side surface of the first spacing element, and an effective focal length f1 of the first lens satisfy: 1.05<(d1s+D1s)/f1<2.2.

A second aspect of the present disclosure provides a visual system, which may include a lens barrel, and a lens group and a spacing element group assembled within the lens barrel, where, the lens group includes, arranged in sequence along an optical axis from a first side to a second side: a first lens having a positive refractive power, a reflective polarizing element, a first quarter wave plate, a second lens having a negative refractive power, a third lens having a refractive power, a partially reflective element, a second quarter wave plate, a polarizer, and a fourth lens having a refractive power; the spacing element group includes: a first spacing element disposed between the first lens and the second lens and against a second side surface of the first lens, a second spacing element disposed between the second lens and the third lens and against a second side surface of the second lens, and a third spacing element disposed between the third lens and the fourth lens and against a second side surface of the third lens; where, the number of lenses having refractive powers in the lens group is four; a spacing EP01 from a first side surface of the lens barrel to a first side surface of the first spacing element along the optical axis and a center thickness CT1 of the first lens on the optical axis satisfy: 1.0<EP01/CT1<1.7; and an inner diameter d1s of the first side surface of the first spacing element, an outer diameter D1s of the first side surface of the first spacing element, and an effective focal length f1 of the first lens satisfy: 1.05<(d1s+D1s)/f1<2.2.

The visual system according to the above implementations of the present disclosure uses a reflex scheme including four lenses, by using a polarized reflex optical path, a body height may be better compressed and an imaging quality may be improved. At the same time, using at least one spacing element, by reasonably allocating the parameters of each lens and each spacing element, at least one aspect such as reducing the risk of stray light in the visual system, improving the processability and moldability of the visual system, improving the assembling stability, or improving the imaging quality can be achieved.

The visual system according to exemplary implementations of the present disclosure may satisfy the conditional expressions: 1.0<EP01/CT1<1.7 and 1.75<d0s/R1<2.3, by reasonably controlling EP01/CT1 and dos/R1 to be within appropriate ranges, an edge thickness and the center thickness of the first lens can be maintained at appropriate levels, which is conducive to improving the molding stability of the first lens, at the same time conducive to improving a light converging ability of the first lens, while satisfying the processability of the first lens, thereby improving the imaging quality and clarity, and improving visual experience.

The visual system according to exemplary implementations of the present disclosure may satisfy the conditional expressions: 1.0<EP01/CT1<1.7 and 1.05<(d1s+D1s)/f1<2.2, by reasonably controlling EP01/CT1 and (d1s+D1s)/f1 to be within appropriate ranges, an edge thickness and the center thickness of the first lens can be maintained at appropriate levels, which is conducive to improving the molding stability of the first lens. At the same time, controlling the ratio of the sum of the inner diameter and the outer diameter of the first side surface of the first spacing element to the effective focal length of the first lens to be within a reasonable range, is conducive to reducing the generation of stray light in the system and improving the imaging quality of the system, on the basis of ensuring the processability thereof. Further, by setting the first spacing element, it is conducive to improving the ability of the lens assembly to resist vibration and drop reliability.

### BRIEF DESCRIPTION OF THE DRAWINGS

Other features, objectives and advantages of the present disclosure will become more apparent by reading the following detailed description for non-limiting embodiments with reference to the accompanying drawings. In the accompanying drawings:

FIG. 1 is a schematic diagram of a structure and some parameters of a visual system according to exemplary implementations of the present disclosure;

FIG. 2 is a schematic structural diagram of a visual assembly according to Embodiment 1 of the present disclosure;

FIG. 3 is a schematic structural diagram of a visual assembly according to Embodiment 2 of the present disclosure;

FIG. 4 is a schematic structural diagram of a visual assembly according to Embodiment 3 of the present disclosure;

FIG. 5A, FIG. 5B and FIG. 5C respectively illustrate a longitudinal aberration curve, an astigmatic curve and a distortion curve of the visual system according to Embodiment 1, Embodiment 2 or Embodiment 3 of the present disclosure;

FIG. 6 illustrates an MTF curve of the visual system according to Embodiment 1, Embodiment 2 or Embodiment 3 of the present disclosure;

FIG. 7 is a schematic structural diagram of a visual assembly according to Embodiment 4 of the present disclosure;

FIG. 8 is a schematic structural diagram of a visual assembly according to Embodiment 5 of the present disclosure;

FIG. 9 is a schematic structural diagram of a visual assembly according to Embodiment 6 of the present disclosure;

FIG. 10A, FIG. 10B and FIG. 10C respectively illustrate a longitudinal aberration curve, an astigmatic curve and a distortion curve of the visual system according to Embodiment 4, Embodiment 5 or Embodiment 6 of the present disclosure;

FIG. 11 illustrates an MTF curve of the visual system according to Embodiment 4, Embodiment 5 or Embodiment 6 of the present disclosure;

FIG. 12 is a schematic structural diagram of a visual assembly according to Embodiment 7 of the present disclosure;

FIG. 13 is a schematic structural diagram of a visual assembly according to Embodiment 8 of the present disclosure;

FIG. 14 is a schematic structural diagram of a visual assembly according to Embodiment 9 of the present disclosure;

FIG. 15A, FIG. 15B and FIG. 15C respectively illustrate a longitudinal aberration curve, an astigmatic curve and a distortion curve of the visual system according to Embodiment 7, Embodiment 8 or Embodiment 9 of the present disclosure; and

FIG. 16 illustrates an MTF curve of the visual system according to Embodiment 7, Embodiment 8 or Embodiment 9 of the present disclosure.

### DETAILED DESCRIPTION OF EMBODIMENTS

For a better understanding of the present disclosure, various aspects of the present disclosure will be described in more detail with reference to the accompanying drawings. It should be understood that the detailed description is merely an illustration for the exemplary implementations of the present disclosure, rather than a limitation to the scope of the present disclosure in any way. Throughout the specification, the same reference numerals designate the same elements. The expression “and/or” includes any and all combinations of one or more of the associated listed items.

It should be noted that, in the specification, the expressions such as “first,” “second” and “third” are only used to distinguish one feature from another, rather than represent any limitations to the features. Thus, the first lens discussed below may also be referred to as the second lens or the third lens without departing from the teachings of the present disclosure.

In the accompanying drawings, the thicknesses, sizes and shapes of the lenses/lens piece are slightly exaggerated for the convenience of explanation. Specifically, the shapes of spherical surfaces or aspheric surfaces shown in the accompanying drawings are shown by examples. That is, the shapes of the spherical surfaces or the aspheric surfaces are not limited to the shapes of the spherical surfaces or the aspheric surfaces shown in the accompanying drawings. The accompanying drawings are merely illustrative and not strictly drawn to scale.

Herein, a paraxial area refers to an area near the optical axis. If a lens surface is a convex surface and the position of the convex surface is not defined, it represents that the lens surface is a convex surface at least at the paraxial area. If the lens surface is a concave surface and the position of the concave surface is not defined, it represents that the lens is a concave surface at least at the paraxial area.

It should be further understood that the terms “comprise,” “comprising,” “having,” “include” and/or “including,” when used in the specification, specify the presence of stated features, elements and/or components, but do not exclude the presence or addition of one or more other features, elements, components and/or combinations thereof. In addition, when expressions such as “at least one of . . . ” appears after a list of listed features, it modifies the entire listed features, rather than the individual elements in the list. In addition, the use of “may,” when describing implementations of the present disclosure, represents “one or more implementations of the present disclosure.” Also, the term “exemplary” is intended to refer to an example or illustration.

Unless otherwise defined, all terms (including technical and scientific terms) used herein have the same meaning as commonly understood by those of ordinary skill in the art to which the present disclosure belongs. It should be further understood that terms (e.g., those defined in commonly used dictionaries) should be interpreted as having a meaning that is consistent with their meaning in the context of the relevant art and will not be interpreted in an idealized or overly formal sense unless expressly so defined herein.

It should be noted that implementations in the present disclosure and the features in the embodiments may be combined with each other on a non-conflict basis. The following embodiments only express several implementations of the present disclosure, and their descriptions are more specific and detailed, but they should not be construed as limiting the scope of present disclosure. It should be noted that for ordinary technicians in this field, several modifications and improvements can be made without departing from the concept of the present disclosure, all of which fall within the scope of protection of present disclosure. For example, the lens groups (i.e., the first lens to the fourth lens), lens barrel structures, and spacer elements in the various embodiments of present disclosure may be combined in any manner, which are not limited to the combination of a lens group in one embodiment solely with the lens barrel structure, spacer elements, and so forth of that same embodiment.

Implementations of the present disclosure will be described below in detail with reference to the accompanying drawings.

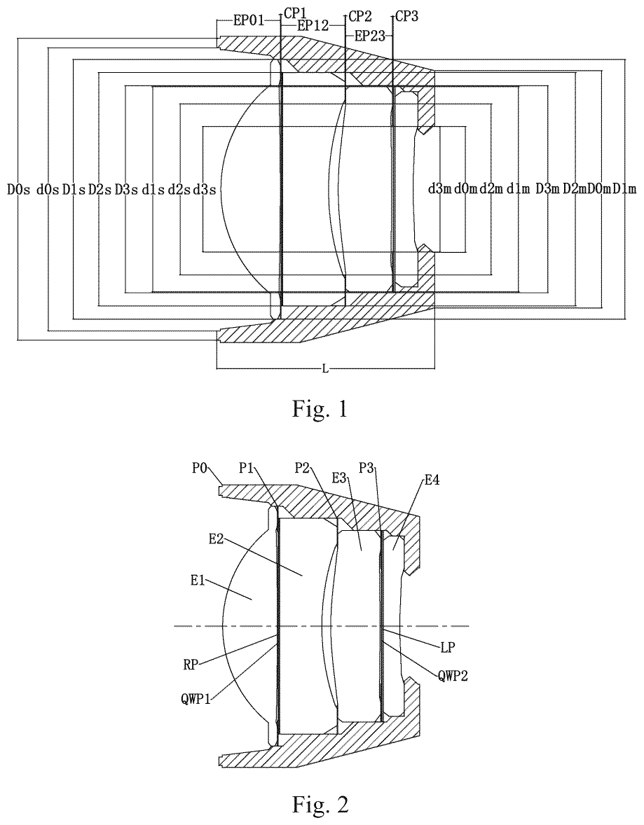

FIG. 1 is a schematic diagram of structural arrangement and some parameters of a visual system according to exemplary implementations of the present disclosure. Referring to FIG. 1, CP1 represents a maximal thickness of a first spacing element, CP2 represents a maximal thickness of a second spacing element, CP3 represents a maximal thickness of a third spacing element, EP01 represents a spacing from a first side surface of a lens barrel to a first side surface of the first spacing element along an optical axis, EP12 represents a spacing from a second side surface of the first spacing element to a first side surface of the second spacing element along the optical axis, EP23 represents a spacing from a second side surface of the second spacing element to a first side surface of the third spacing element along the optical axis, L represents a spacing from the first side surface of the lens barrel to a second side surface of the lens barrel along the optical axis (L may also be referred to as a maximal length of the lens barrel), D0s represents an outer diameter of the first side surface of the lens barrel, dos represents an inner diameter of the first side surface of the lens barrel, D1s represents an outer diameter of the first side surface of the first spacing element, d1s represents an inner diameter of the first side surface of the first spacing element, D2s represents an outer diameter of the first side surface of the second spacing element, d2s represents an inner diameter of the first side surface of the second spacing element, D3s represents an outer diameter of the first side surface of the third spacing element, d3s represents an inner diameter of the first side surface of the third spacing element, d0m represents an inner diameter of the second side surface of the lens barrel, D1m represents an outer diameter of the second side surface of the first spacing element, d1m represents an inner diameter of the second side surface of the first spacing element, D2m represents an outer diameter of the second side surface of the second spacing element, d2m represents an inner diameter of the second side surface of the second spacing element, d3m represents an inner diameter of a second side surface of the third spacing element, D3m represents an outer diameter of the second side surface of the third spacing element, and so on.

With reference to FIGS. 2-4, FIGS. 7-9, and FIGS. 12-14, a first aspect of the present disclosure provides a visual system, which may include a lens group, a spacing element group and a lens barrel, where, the lens group and the spacing element group are assembled within the lens barrel.

In exemplary implementations, the lens barrel P0 may include the first side surface, the second side surface, an outer annular surface and an inner annular surface, where the first side surface of the lens barrel may be, for example, an end surface closest to a first side, and the second side surface of the lens barrel may be, for example, an end surface closest to a second side; and in a direction perpendicular to the optical axis, the surface furthest away from the optical axis of the lens barrel is the outer annular surface, and the surface closest to the optical axis of the lens barrel is the inner annular surface.

In exemplary implementations, the lens group may be a four-piece lens group, which may include, disposed in sequence along the optical axis from the first side to the second side: a first lens E1, a reflective polarizing element RP, a first quarter wave plate QWP1, a second lens E2, a third lens E3, a partially reflective element BS (not shown in the drawing), a second quarter wave plate QWP2, a polarizer LP, and a fourth lens E4. There may be an air spacing between any adjacent lenses. In the exemplary implementations, the second side of the visual system may also include a display screen.

In exemplary implementations, the first side of the visual system may be, for example, the side close to a human eye, and the second side may be, for example, the side close to a display. Accordingly, each optical element (the first lens, the reflective polarizing element, the first quarter wave plate, the second lens, the third lens, the partially reflective element, the second quarter wave plate, the polarizer, the fourth lens, or the like) has at least one first side surface that is relatively close to the human eye, and has at least one second side surface that is relatively close to the display.

In exemplary implementations, the first lens E1 may have a positive refractive power. The first side surface of the first lens E1 may be a convex surface, and the second side surface of the first lens E1 may be a convex surface or a concave surface.

In the exemplary implementations, the second lens E2 may have a negative refractive power. The first side surface of the second lens E2 may be a planar surface, and the second side surface of the second lens E2 may be a concave surface. The first quarter wave plate QWP1 may be disposed on the first side surface (the side surface that is close to the human eye) of the second lens E2 and at least partially adhered to the first side surface of the second lens E2, and the reflective polarizing element RP may be disposed on the first side surface (the side surface that is close to the human eye) of the first quarter wave plate QWP1 and at least partially adhered to the first side surface of the first quarter wave plate QWP1. Exemplarily, the first quarter wave plate QWP1 and the reflective polarizing element RP may be sequentially attached to the first side surface of the second lens E2, or the two elements may be combined together to achieve one-time attachment, thereby improving production efficiency and reducing costs. At the same time, the first quarter wave plate QWP1 and the reflective polarizing element RP combining together may also avoid angular deviation between the optical axis of the reflective polarizing element and the optical axis of the first quarter wave plate due to the attachment process, thereby improving an imaging quality.

In exemplary implementations, the third lens E3 may have a positive refractive power or a negative refractive power. The first side surface of the third lens E3 may be a convex surface or a concave surface, and the second side surface of the third lens E3 may be a convex surface. The partially reflective element BS may be disposed on the second side surface of the third lens E3 and at least partially adhered to the second side surface of the third lens E3.

In exemplary implementations, the fourth lens E4 may have a positive refractive power or a negative refractive power. The first side surface of the fourth lens E4 may be a planar surface, and the second side surface of the fourth lens E4 may be a concave surface or a convex surface. The polarizer LP may be disposed on the first side surface (the side surface that is close to the human eye) of the fourth lens E4 and at least partially adhered to the first side surface of the fourth lens E4, and the second quarter wave plate QWP2 may be disposed on the first side surface (the side surface that is close to the human eye) of the polarizer LP and at least partially adhered to the first side surface of the polarizer LP. Exemplarily, the polarizer LP and the second quarter wave plate QWP2 may be sequentially attached to the first side surface of the fourth lens E4.

In the visual system according to exemplary implementations of the present disclosure, when light passes through the reflective polarizing element, the reflective polarizing element may reflect light of a certain direction and transmit light orthogonal to the reflected light. The quarter wave plates may be used to convert between circularly polarized light and linearly polarized light, enabling optical path reflexing. The partially reflective element may be a partially reflective layer (e.g., a semi-transmissive and semi-reflective film) attached or plated to the second side surface of the third lens, the partially reflective layer having a semi-transmissive and semi-reflective effect on the light. The effect of the polarizer is to change natural light emitted from the screen into linearly polarized light. Image light from the display screen is refracted and reflected multiple times by the visual system and finally projected to users' eyes.

The visual system provided according to implementations of the present disclosure may be applied to head-mounted apparatuses of virtual reality devices such as VR, AR, or MR devices. In particular, the visual system, which may be used as a head-mounted apparatus, may compress a body length of the lens assembly through optical path reflexing, thereby shifting the center of gravity of the head-mounted apparatus backward, and enhancing consumer experience.

In exemplary implementations, the spacing element group may include one or more of a first spacing element, a second spacing element, and a third spacing element. The first spacing element may be disposed between the first lens and the second lens and against the second side surface of the first lens. The second spacing element may be disposed between the second lens and the third lens and against the second side surface of the second lens. The third spacing element may be disposed between the third lens and the fourth lens and against the second side surface of the third lens. Reasonably using the spacing elements can effectively avoid the risk of stray light, reduce interference with an image quality, and then improve the imaging quality of the visual system, which is also conducive to improving the assembling stability of the system, so as to ensure that the system has good structural performance.

In exemplary implementations, the lens group may have at least one edged lens. An outer peripheral surface of the edged lens may have an edged portion and a non-edged portion, and an outer diameter of the edged portion of the lens is smaller than an outer diameter of the non-edged portion of the lens. When the outer peripheral surface of the lens has an edged portion, the outer diameter of the lens usually refers to the outer diameter of the non-edged portion of the lens, while the outer diameter of the spacing element usually refers to a maximal outer diameter of the non-edged portion.

In exemplary implementations, the spacing EP01 from the first side surface of the lens barrel to the first side surface of the first spacing element along the optical axis and a center thickness CT1 of the first lens on the optical axis may satisfy: 1.0<EP01/CT1<1.7; and the inner diameter dos of the first side surface of the lens barrel and a radius of curvature R1 of the first side surface of the first lens may satisfy: 1.75<d0s/R1<2.3. Satisfying the conditional expressions: 1.0<EP01/CT1<1.7 and 1.75<d0s/R1<2.3, by reasonably controlling EP01/CT1 and dos/R1 to be within appropriate ranges, an edge thickness and the center thickness of the first lens can be maintained at appropriate levels, which is conducive to improving the molding stability of the first lens, at the same time conducive to improving a light converging ability of the first lens while satisfying the processability of the first lens, thereby improving the imaging quality and clarity, and improving visual experience.

In exemplary implementations, the spacing EP12 from the second side surface of the first spacing element to the first side surface of the second spacing element along the optical axis, a center thickness CT2 of the second lens on the optical axis, and an axial distance T23 from the second side surface of the second lens to the first side surface of the third lens may satisfy: 0.2<EP12/(CT2+T23)<1.2. Satisfying this conditional expression helps to control an edge thickness of the second spacing element, combining with controlling the center thickness and spacing of the second lens, helps to control uniform thickness of the second lens as a whole, and to enhance molding strength of the second lens, which is also conducive to reducing a body height, so that the entire lens group is more compact, and a miniaturized design can be achieved.

In exemplary implementations, the outer diameter D1m of the second side surface of the first spacing element and the outer diameter D2m of the second side surface of the second spacing element may satisfy: 1.0<D1m/D2m<1.2. Satisfying this conditional expression, by controlling the outer diameter of the second side surface of the first spacing element and the outer diameter of the second side surface of the second spacing element, helps to control the outer diameter of the second lens and the outer diameter of the third lens, thereby controlling an assembling mismatch between the second lens and the third lens, improving the assembling stability of the system.

In exemplary implementations, the inner diameter d2s of the first side surface of the second spacing element, the inner diameter d2m of the second side surface of the second spacing element, a radius of curvature R4 of the second side surface of the second lens, and a radius of curvature R5 of the first side surface of the third lens may satisfy: 0.2<(d2s+d2m)/(R4+R5)<0.65. Satisfying this conditional expression is conducive to reducing the sensitivity of the second lens and the third lens, thereby improving an assembling yield, which also helps to block stray light in the lens assembly and improve the imaging quality of the lens assembly.

In the exemplary implementations, the inner diameter d3s of the first side surface of the third spacing element and a center thickness CT3 of the third lens on the optical axis may satisfy: 2.0<d3s/CT3<2.95. Satisfying this conditional expression helps to ensure stability of the surface type of the second side surface of the third lens, thereby improving the molding stability of the third lens.

In exemplary implementations, the inner diameter d0m of the second side surface of the lens barrel, a center thickness CTQ2 of the second quarter wave plate on the optical axis, a center thickness CTL of the polarizer on the optical axis, and a center thickness CT4 of the fourth lens on the optical axis may satisfy: 6.2<d0m/(CTQ2+CTL+CT4)<9.9. Satisfying this conditional expression helps to limit a total track length of the system, achieve a compact design of the optical system, reduce a volume and weight of the device, and improve the ease of wearing, which also helps to ensure the strength of the second quarter wave plate and the polarizer, and is conducive to the attachment of the second quarter wave plate and the polarizer.

In exemplary implementations, the inner diameter dim of the second side surface of the first spacing element and a combined focal length fz1 of the reflective polarizing element, the first quarter wave plate and the second lens may satisfy:

0.65<d1m/fz1<−0.05. Satisfying this conditional expression helps to optimize the performance of the optical system, including improving imaging quality, enhancing light focusing capability, and reducing or eliminating distortion, thereby improving the clarity and accuracy of images. In addition, satisfying this conditional expression also helps to control admitted light of the optical system, so that a field-of-view of the optical system is within a reasonable range.

In exemplary implementations, the inner diameter d3m of the second side surface of the third spacing element, the outer diameter D3m of the second side surface of the third spacing element, and a combined focal length fz2 of the second quarter wave plate, the polarizer and the fourth lens may satisfy: 0.2<(d3m+D3m)/|fz2|<1.0. Satisfying this conditional expression can, on the one hand, provide a wider field-of-view, enabling users to see more virtual or augmented reality content, and on the other hand, help to block stray light in the lens assembly, and further improve the imaging quality of the lens assembly.

In exemplary implementations, the outer diameter D3s of the first side surface of the third spacing element and a radius of curvature R6 of the second side surface of the third lens may satisfy: −0.3<D3s/R6<0. Satisfying this conditional expression helps to control the outer diameter of the first side surface of the third lens, so that the ratio of the outer diameter of the first side surface of the third lens to the radius of curvature of the second side surface of the third lens is within a reasonable range, which helps to control the shape of the third lens and ensure that the third lens has good processability.

In exemplary implementations, the outer diameter D0s of the first side surface of the lens barrel, an outer diameter D0m of the second side surface of the lens barrel, and the spacing L from the first side surface of the lens barrel to the second side surface of the lens barrel along the optical axis may satisfy: 0.15<(D0s−D0m)/L<0.55. Satisfying this conditional expression helps to control the total track length TTL of the lens assembly mechanism to meet module needs, thereby achieving the miniaturized design of the lens assembly.

In exemplary implementations, the maximal thickness CP2 of the second spacing element, the spacing EP23 from the second side surface of the second spacing element to the first side surface of the third spacing element along the optical axis, the center thickness CT3 of the third lens on the optical axis, and an axial distance T34 from the second side surface of the third lens to the first side surface of the fourth lens may satisfy: 0.8<(CP2+EP23)/(CT3+T34)<2.2. Satisfying this conditional expression, by controlling the spacing from the second side surface of the second spacing element to the first side surface of the third spacing element, helps to control an edge thickness of the third lens. At the same time, controlling the center thickness and the spacing of the third lens helps to ensure uniform thickness of the third lens as a whole, improve stability of the surface type of the third lens, and avoid interfering with each other during assembly, thereby improving an assembly yield.

In exemplary implementations, the outer diameter D2s of the first side surface of the second spacing element and an effective focal length f2 of the second lens may satisfy: −0.85<D2s/f2<−0.1. Satisfying this conditional expression helps to control the shape of the second lens, reduce the difficulty of processing and molding the second lens, thereby further improving the processability of the second lens.

In exemplary implementations, the maximal thickness CP1 of the first spacing element and the maximal thickness CP3 of the third spacing element may satisfy: 0.4<CP1/CP3<1.05. Satisfying this conditional expression, controlling the ratio of the maximal thickness of the first spacing element to the maximal thickness of the third spacing element, helps to control the spacing between the first lens and the second lens and the spacing between the third lens and the fourth lens, which helps to adjust the spacings by controlling the thickness of the first spacing element and the thickness of the third spacing element during assembly, thereby improving the performance of the optical system, and improving the assembly stability.

In exemplary implementations, the inner diameter d1s of the first side surface of the first spacing element, the outer diameter D1s of the first side surface of the first spacing element, and an effective focal length f1 of the first lens may satisfy: 1.05<(d1s+D1s)/f1<2.2. Satisfying this conditional expression, controlling the ratio of the sum of the inner and outer diameters of the first side surface (far side) of the first spacing element to the effective focal length of the first lens to be within a reasonable range, is conducive to reducing the generation of stray light in the system and improving the imaging quality of the system, on the basis of ensuring the processability thereof. Further, by setting the first spacing element and making use of cushioning properties of the material of the first spacing element, the reflective polarizing element and the quarter wave plates may be avoided from coming into direct contact with rigid plastic, thereby improving the ability of the lens assembly to resist vibration and drop reliability.

A second aspect of the present disclosure provides a visual system, including a lens barrel, and a four-piece lens group and a spacing element group assembled within the lens barrel. The four-piece lens group includes, disposed in sequence along an optical axis from a first side to a second side: a first lens E1, a reflective polarizing element RP, a first quarter wave plate QWP1, a second lens E2, a third lens E3, a partially reflective element BS, a second quarter wave plate QWP2, a polarizer LP, and a fourth lens E4. The spacing element group may include one or more of a first spacing element, a second spacing element, and a third spacing element. The first spacing element may be disposed between the first lens and the second lens and against a second side surface of the first lens. The second spacing element may be disposed between the second lens and the third lens and against a second side surface of the second lens. The third spacing element may be disposed between the third lens and the fourth lens and against a second side surface of the third lens.

In exemplary implementations, the first lens E1 may have a positive refractive power. A first side surface of the first lens E1 may be a convex surface, and the second side surface of the first lens E1 may be a convex surface or a concave surface. The second lens E2 may have a negative refractive power. A first side surface of the second lens E2 may be a planar surface, and the second side surface of the second lens E2 may be a concave surface. The first quarter wave plate QWP1 may be disposed on the first side surface (the side surface that is close to a human eye) of the second lens E2 and at least partially adhered to the first side surface of the second lens E2, and the reflective polarizing element RP may be disposed on the first side surface (the side surface that is close to the human eye) of the first quarter wave plate QWP1 and at least partially adhered to the first side surface of the first quarter wave plate QWP1. The third lens E3 may have a positive refractive power or a negative refractive power. A first side surface of the third lens E3 may be a convex surface or a concave surface, and the second side surface of the third lens E3 may be a convex surface. The partially reflective element BS may be disposed on the second side surface of the third lens E3 and at least partially adhered to the second side surface of the third lens E3. The fourth lens E4 may have a positive refractive power or a negative refractive power. A first side surface of the fourth lens E4 may be a planar surface, and a second side surface of the fourth lens E4 may be a concave surface or a convex surface. The polarizer LP may be disposed on the first side surface (the side surface that is close to the human eye) of the fourth lens E4 and at least partially adhered to the first side surface of the fourth lens E4, and the second quarter wave plate QWP2 may be disposed on the first side surface (the side surface that is close to the human eye) of the polarizer LP and at least partially adhered to the first side surface of the polarizer LP.

In exemplary implementations, the spacing EP01 from the first side surface of the lens barrel to the first side surface of the first spacing element along the optical axis and a center thickness CT1 of the first lens on the optical axis may satisfy: 1.0<EP01/CT1<1.7; and the inner diameter d1s of the first side surface of the first spacing element, the outer diameter D1s of the first side surface of the first spacing element, and an effective focal length f1 of the first lens may satisfy: 1.05<(d1s+D1s)/f1<2.2. Satisfying the conditional expressions: 1.0<EP01/CT1<1.7 and 1.05<(d1s+D1s)/f1<2.2, by reasonably controlling EP01/CT1 and (d1s+D1s)/f1 to be within appropriate ranges, on the one hand, an edge thickness and the center thickness of the first lens can be maintained at appropriate levels, which is conducive to improving the molding stability of the first lens, at the same time conducive to improving a light converging ability of the first lens, while satisfying the processability of the first lens, thereby improving the imaging quality and clarity, and improving visual experience. On the other hand, controlling the ratio of the sum of the inner and outer diameters of the first side surface (far side) of the first spacing element to the effective focal length of the first lens to be within a reasonable range, is conducive to reducing the generation of stray light in the system and improving the imaging quality of the system, on the basis of ensuring the processability thereof. Further, by setting the first spacing element and making use of cushioning properties of the material of the first spacing element, the reflective polarizing element and the quarter wave plates may be avoided from coming into direct contact with rigid plastic, thereby improving the ability of the lens assembly to resist vibration and drop reliability.

In exemplary implementations, the visual system may further include a diaphragm STO provided close to the human eye side. The diaphragm STO may be provided, for example, on a first side of the first lens E1.

In exemplary implementations, at least one of the surfaces of the lenses in the first lens to the fourth lens is an aspheric surface. An aspheric lens has a better radius-of-curvature characteristic, and has advantages of improving a distortion aberration and an astigmatic aberration. The use of the aspheric lens can eliminate as much as possible the aberrations that occur during the imaging, thereby improving the imaging quality.

The visual system according to the above implementations of the present disclosure uses a reflex scheme including four lenses, by using a polarized reflex optical path, a body height may be better compressed and an imaging quality may be improved. At the same time, using at least one spacing element, by reasonably allocating the parameters of each lens and each spacing element, at least one aspect such as reducing the risk of stray light in the visual system, improving the processability and moldability of the visual system, improving the assembling stability, or improving the imaging quality can be achieved.

It should be understood by those skilled in the art that the number of lenses and spacing elements constituting the visual system can be changed to obtain the various results and advantages described in this specification, without departing from the technical solution claimed by the present disclosure.

Detailed embodiments of the visual system that may be applicable to the above implementations are further described below with reference to the accompanying drawings.

### Embodiment 1

A visual system according to Embodiment 1 of the present disclosure is described below with reference to FIG. 2.

As shown in FIG. 2, the visual system includes a lens barrel P0 and a four-piece lens group and a spacing element group assembled within the lens barrel P0.

Here, the four-piece lens group includes, in sequence along an optical axis from a first side (e.g., the side that is close to a human eye) to a second side (e.g., the side that is close to a display): a first lens E1, a reflective polarizing element RP, a first quarter wave plate QWP1, a second lens E2, a third lens E3, a partially reflective element BS (not shown in the drawing), a second quarter wave plate QWP2, a polarizer LP, and a fourth lens E4.

The spacing element group includes a first spacing element P1, a second spacing element P2, and a third spacing element P3. The spacing element may block excess light during imaging from entering a next lens, while enabling a better support between the lens and the lens barrel, enhancing the structural stability of the visual system.

The visual system may further include a diaphragm STO provided close to the human eye side. The diaphragm STO may be provided on a first side of the first lens E1.

In this embodiment, the first lens E1 has a positive refractive power, a first side surface of the first lens E1 is a convex surface, and a second side surface of the first lens E1 is a convex surface. The second lens E2 has a negative refractive power, a first side surface of the second lens E2 is a planar surface, a second side surface of the second lens E2 is a concave surface, and the first quarter wave plate QWP1 and the reflective polarizing element RP are sequentially attached to the first side surface of the second lens E2. The third lens E3 has a positive refractive power, a first side surface of the third lens E3 is a convex surface, and a second side surface of the third lens E3 is a convex surface. The partially reflective element BS is attached to the second side surface of the third lens E3. The fourth lens E4 has a negative refractive power, a first side surface of the fourth lens E4 is a planar surface, and a second side surface of the fourth lens E4 is a concave surface. The polarizer LP and the second quarter wave plate QWP2 are sequentially attached to the first side surface of the fourth lens E4. There may also be an optical element between the fourth lens E4 and an image surface (IMG), which may be an optical filter or a protective glass, or the like.

Table 1 shows a table of basic parameters of the visual system in Embodiment 1. Here, the units of a radius of curvature, a thickness/distance are all millimeters (mm). Image light from a display screen passes through the optical surfaces of each element in sequence and is finally projected into the human eye.

TABLE 1

| | | | | | material | | | |
|---|---|---|---|---|---|---|---|---|
| surface | | surface | radius of | thickness/ | refractive | abbe | refraction/ | conic |
| number | optical element | type | curvature | distance | index | number | reflection | coefficient |
| 0 | | | infinite | −100000.0000 | | | refraction | |
| 1 | diaphragm (STO) | | infinite | 20.0000 | | | refraction | |
| 2 | first lens (E1) | spherical | 17.7201 | 7.7914 | 1.569 | 63.11 | refraction | |
| 3 | | spherical | −500.0000 | 0.1000 | | | refraction | |
| 4 | reflective polarizing | | infinite | 0.1100 | 1.502 | 57.00 | refraction | |
| | element (RP) | | | | | | | |
| 5 | first quarter wave | | infinite | 0.1100 | 1.502 | 57.00 | refraction | |
| | plate (QWP1) | | | | | | | |
| 6 | second lens (E2) | | infinite | 6.0000 | 1.779 | 34.53 | refraction | |
| 7 | | spherical | 34.2647 | 1.2672 | | | refraction | |
| 8 | third lens (E3) | aspheric | 40.9357 | 7.0000 | 1.546 | 55.92 | refraction | 0.0000 |
| 9 | partially reflective | aspheric | −493.3839 | −7.0000 | 1.546 | 55.92 | refraction | 0.0000 |
| | element (BS) | | | | | | | |
| 10 | | aspheric | 40.9357 | −1.2672 | | | refraction | 0.0000 |
| 11 | | spherical | 34.2647 | −6.0000 | 1.779 | 34.53 | refraction | |
| 12 | | | infinite | −0.1100 | 1.502 | 57.00 | refraction | |
| 13 | reflective polarizing | | infinite | 0.1100 | 1.502 | 57.00 | refraction | |
| | element (RP) | | | | | | | |
| 14 | second lens (E2) | | infinite | 6.0000 | 1.779 | 34.53 | refraction | |
| 15 | | spherical | 34.2647 | 1.2672 | | | refraction | |
| 16 | third lens (E3) | aspheric | 40.9357 | 7.0000 | 1.546 | 55.92 | refraction | 0.0000 |
| 17 | | aspheric | −493.3839 | 0.2000 | | | refraction | 0.0000 |
| 18 | second quarter wave | | infinite | 0.1100 | 1.502 | 57.00 | refraction | |
| | plate (QWP2) | | | | | | | |
| 19 | polarizer (LP) | | infinite | 0.1500 | 1.502 | 57.00 | refraction | |
| 20 | fourth lens (E4) | | infinite | 2.3653 | 1.500 | 57.28 | refraction | |
| 21 | | aspheric | 60.4204 | 0.9861 | | | refraction | 0.0000 |
| 22 | | | infinite | 0.7100 | 1.519 | 64.17 | refraction | |
| 23 | | | infinite | 0.1000 | | | refraction | |
| 24 | image surface (IMG) | | infinite | 0.0000 | | | refraction | |

In this embodiment, the first side surface S16 and the second side surface S17 of the third lens, and the second side surface S21 of the fourth lens E4 are aspheric surfaces, the surface type x of each aspheric lens may be defined using, but not limited to, the following aspheric formula:

$$x = \frac{c {h}^{2}}{1 + \sqrt{1 - ( k + 1 ) {c}^{2} {h}^{2}}} + \sum Ai {h}^{i} \qquad ( 1 )$$

Here, x is the sag—the axis-component of the displacement of the surface from the aspheric vertex, when the surface is at height h from the optical axis; c is the paraxial curvature of the aspheric surface, and c=1/R (i.e., the paraxial curvature c is the reciprocal of the radius of curvature R in Table 1 above); k is the conic coefficient; and Ai is the correction coefficient of an i-th order of the aspheric surface.

Table 2 shows the high-order coefficients A₄, A₆, A₈, A₁₀, A₁₂, A₁₄, A₁₆, A₁₈ and A₂₀ applicable to the aspheric surfaces S16, S17, S21 in Embodiment 1.

TABLE 2

surface number

| coefficient | S16 | S17 | S21 |
|---|---|---|---|
| A4 | −7.1874E−01 | 1.0574E+00 | −1.8584E−01 |
| A6 | 7.2814E−01 | 3.4208E−01 | −3.6156E−03 |
| A8 | 2.7264E−01 | −1.1471E−01 | −2.2890E−04 |
| A10 | 8.7554E−02 | −1.6160E−01 | 3.2741E−04 |
| A12 | 2.8686E−02 | −8.2154E−02 | −8.0570E−04 |
| A14 | 5.9606E−03 | −2.3484E−02 | −3.3659E−04 |
| A16 | 2.2679E−04 | −3.1671E−03 | −3.6592E−04 |
| A18 | 0.0000E+00 | 0.0000E+00 | 0.0000E+00 |
| A20 | 0.0000E+00 | 0.0000E+00 | 0.0000E+00 |

### Embodiment 2

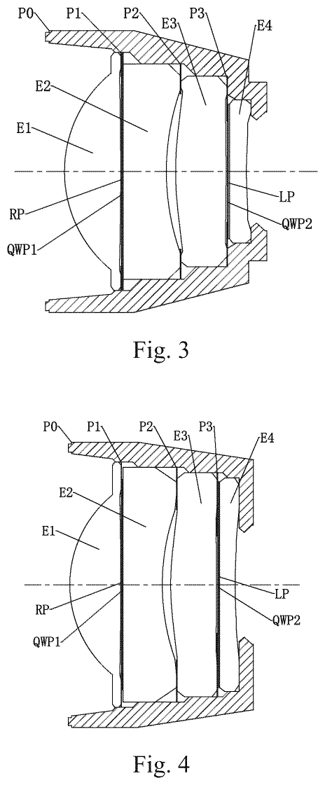

A visual system according to Embodiment 2 of the present disclosure is described below with reference to FIG. 3.

As shown in FIG. 3, the visual system includes a lens barrel P0 and a four-piece lens group and a spacing element group assembled within the lens barrel P0. Here, the four-piece lens group includes, in sequence along an optical axis from a first side (e.g., the side that is close to a human eye) to a second side (e.g., the side that is close to a display): a first lens E1, a reflective polarizing element RP, a first quarter wave plate QWP1, a second lens E2, a third lens E3, a partially reflective element BS (not shown in the drawing), a second quarter wave plate QWP2, a polarizer LP, and a fourth lens E4. The spacing element group includes a first spacing element P1, a second spacing element P2, and a third spacing element P3. The visual system may further include a diaphragm STO provided on the side that close to the human eye. The diaphragm STO may be provided on a first side of the first lens E1.

The structures of the lenses in this embodiment are the same as the structures of the lenses in Embodiment 1, i.e., a table of basic parameters of the visual system in this embodiment is the same as that of Table 1, and a table of aspheric coefficients is the same as that of Table 2. In addition, the spacing elements included in the spacing element group of the visual system in this embodiment are also the same as those included in Embodiment 1, and the difference lies only in that: at least one of the parameters such as a maximal length L of the lens barrel, thicknesses of the spacing elements, inner diameters of the spacing elements and outer diameters of the spacing elements, a spacing EP01 from a first side surface of the lens barrel to a first side surface of the first spacing element along the optical axis, and spacings between the spacing elements along the optical axis, is different from that of Embodiment 1.

### Embodiment 3

A visual system according to Embodiment 3 of the present disclosure is described below with reference to FIG. 4.

As shown in FIG. 4, the visual system includes a lens barrel P0 and a four-piece lens group and a spacing element group assembled within the lens barrel P0. Here, the four-piece lens group includes, in sequence along an optical axis from a first side (e.g., the side that is close to a human eye) to a second side (e.g., the side that is close to a display): a first lens E1, a reflective polarizing element RP, a first quarter wave plate QWP1, a second lens E2, a third lens E3, a partially reflective element BS (not shown in the drawing), a second quarter wave plate QWP2, a polarizer LP, and a fourth lens E4. The spacing element group includes a first spacing element P1, a second spacing element P2, and a third spacing element P3. The visual system may further include a diaphragm STO provided close to the human eye side. The diaphragm STO may be provided on a first side of the first lens E1.

The structures of lenses in this embodiment is the same as the structures of lenses in Embodiment 1, i.e., a table of basic parameters of the visual system in this embodiment is the same as that of Table 1, and a table of aspheric coefficients is the same as that of Table 2. In addition, the spacing elements included in the spacing element group of the visual system in this embodiment are also the same as those included in Embodiment 1, and the difference lies only in that: at least one of the parameters such as a maximal length L of the lens barrel, thicknesses of the spacing elements, inner diameters of the spacing elements and outer diameters of the spacing elements, a spacing EP01 from a first side surface of the lens barrel to a first side surface of the first spacing element along the optical axis, and spacings between the spacing elements along the optical axis, is different from that of Embodiment 1.

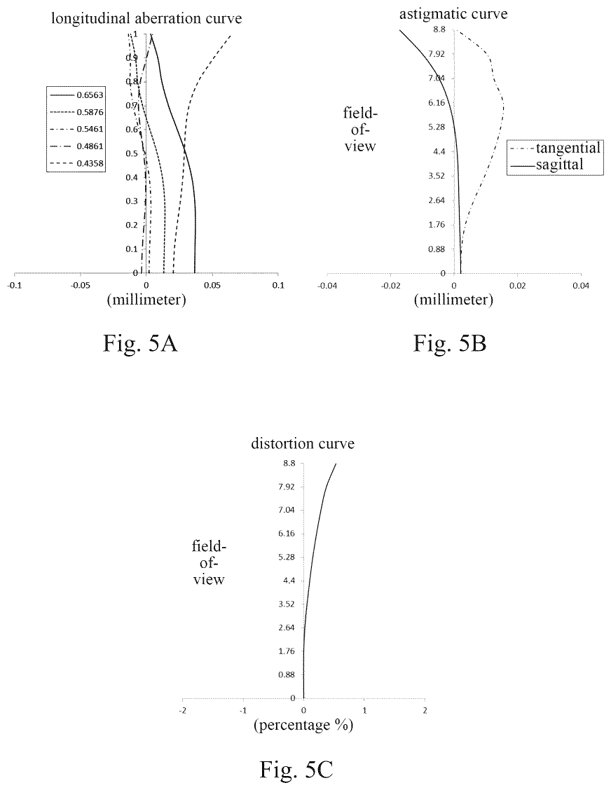

FIG. 5A illustrates a longitudinal aberration curve of the visual system in Embodiment 1, Embodiment 2 or Embodiment 3, representing deviations of focal points at which lights of different wavelengths passing through the visual system converge. FIG. 5B illustrates an astigmatic curve of the visual system in Embodiment 1, Embodiment 2 or Embodiment 3, representing a curvature of a tangential image plane and a curvature of a sagittal image plane corresponding to different fields-of-view. FIG. 5C illustrates a distortion curve of the visual system in Embodiment 1, Embodiment 2 or Embodiment 3, representing amounts of distortion corresponding to different fields-of-view. It can be seen from FIGS. 5A-5C that the visual system given in Embodiment 1, Embodiment 2 or Embodiment 3 can achieve a good imaging quality.

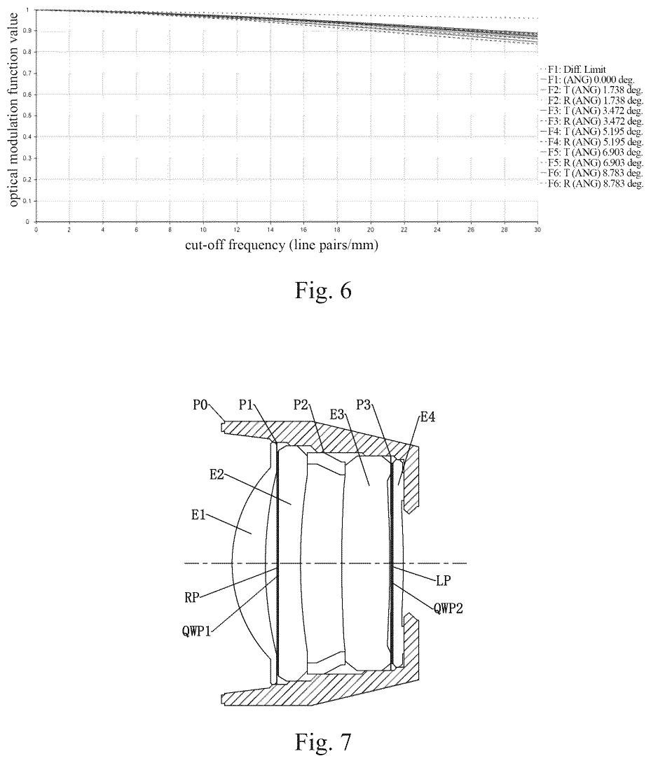

FIG. 6 illustrates an MTF curve of the visual system in Embodiment 1, Embodiment 2 or Embodiment 3. As can be seen from FIG. 6, the visual system in Embodiment 1, Embodiment 2 or Embodiment 3 has good contrast and clear imaging within a spatial frequency of 30 lp/mm.

### Embodiment 4

A visual system according to Embodiment 4 of the present disclosure is described below with reference to FIG. 7.

As shown in FIG. 7, the visual system includes a lens barrel P0 and a four-piece lens group and a spacing element group assembled within the lens barrel P0. Here, the four-piece lens group includes, in sequence along an optical axis from a first side (e.g., the side that is close to a human eye) to a second side (e.g., the side that is close to a display): a first lens E1, a reflective polarizing element RP, a first quarter wave plate QWP1, a second lens E2, a third lens E3, a partially reflective element BS (not shown in the drawing), a second quarter wave plate QWP2, a polarizer LP, and a fourth lens E4. The spacing element group includes a first spacing element P1, a second spacing element P2, and a third spacing element P3. The visual system may further include a diaphragm STO provided close to the human eye side. The diaphragm STO may be provided on a first side of the first lens E1.

In this embodiment, the first lens E1 has a negative refractive power, a first side surface of the first lens E1 is a convex surface, and a second side surface of the first lens E1 is a concave surface. The second lens E2 has a negative refractive power, a first side surface of the second lens E2 is a planar surface, a second side surface of the second lens E2 is a concave surface. The first quarter wave plate QWP1 and the reflective polarizing element RP are sequentially attached to the first side surface of the second lens E2. The third lens E3 has a positive refractive power, a first side surface of the third lens E3 is a convex surface, and a second side surface of the third lens E3 is a convex surface. The partially reflective element BS is attached to the second side surface of the third lens E3. The fourth lens E4 has a positive refractive power, a first side surface of the fourth lens E4 is a planar surface, and a second side surface of the fourth lens E4 is a convex surface. The polarizer LP and the second quarter wave plate QWP2 are sequentially attached to the first side surface of the fourth lens E4. There may also be an optical element between the fourth lens E4 and an image surface (IMG), which may be an optical filter or a protective glass, or the like.

Table 3 shows a table of basic parameters of the visual system in Embodiment 4. Here, the units of a radius of curvature, a thickness/distance are all millimeters (mm).

TABLE 3

| | | | | | material | | | |
|---|---|---|---|---|---|---|---|---|
| surface | | surface | radius of | thickness/ | refractive | abbe | refraction/ | conic |
| number | optical element | type | curvature | distance | index | number | reflection | coefficient |
| 0 | | | infinite | −100000.0000 | | | refraction | |
| 1 | diaphragm (STO) | | infinite | 20.0000 | | | refraction | |
| 2 | first lens (E1) | spherical | 20.0872 | 4.8394 | 1.554 | 63.46 | refraction | |
| 3 | | spherical | 54.7045 | 1.6850 | | | refraction | |
| 4 | reflective polarizing | | infinite | 0.1100 | 1.502 | 57.00 | refraction | |
| | element (RP) | | | | | | | |
| 5 | first quarter wave | | infinite | 0.1100 | 1.502 | 57.00 | refraction | |
| | plate (QWP1) | | | | | | | |
| 6 | second lens (E2) | | infinite | 3.1981 | 1.728 | 29.23 | refraction | |
| 7 | | spherical | 83.9381 | 5.9673 | | | refraction | |
| 8 | third lens (E3) | aspheric | 124.0097 | 7.0000 | 1.500 | 57.28 | refraction | 0.0000 |
| 9 | partially reflective | aspheric | −171.4699 | −7.0000 | 1.500 | 57.28 | refraction | 0.0000 |
| | element (BS) | | | | | | | |
| 10 | | aspheric | 124.0097 | −5.9673 | | | refraction | 0.0000 |
| 11 | | spherical | 83.9381 | −3.1981 | 1.728 | 29.23 | refraction | |
| 12 | | | infinite | −0.1100 | 1.502 | 57.00 | refraction | |
| 13 | reflective polarizing | | infinite | 0.1100 | 1.502 | 57.00 | refraction | |
| | element (RP) | | | | | | | |
| 14 | second lens (E2) | | infinite | 3.1981 | 1.728 | 29.23 | refraction | |
| 15 | | spherical | 83.9381 | 5.9673 | | | refraction | |
| 16 | third lens (E3) | aspheric | 124.0097 | 7.0000 | 1.500 | 57.28 | refraction | 0.0000 |
| 17 | | aspheric | −171.4699 | 0.2000 | | | refraction | 0.0000 |
| 18 | second quarter wave | | infinite | 0.1100 | 1.502 | 57.00 | refraction | |
| | plate (QWP2) | | | | | | | |
| 19 | polarizer (LP) | | infinite | 0.1500 | 1.502 | 57.00 | refraction | |
| 20 | fourth lens (E4) | | infinite | 1.4998 | 1.668 | 20.37 | refraction | |
| 21 | | aspheric | −147.0335 | 1.3204 | | | refraction | 0.0000 |
| 22 | | | infinite | 0.7100 | 1.519 | 64.17 | refraction | |
| 23 | | | infinite | 0.1000 | | | refraction | |
| 24 | image surface (IMG) | | infinite | 0.0000 | | | refraction | |

In this embodiment, the first side surface S16 and the second side surface S17 of the third lens, and the second side surface S21 of the fourth lens E4 are aspheric surfaces, the surface type x of each aspheric lens may be defined using, but not limited to, the formula (1) given in the above Embodiment 1.

Table 4 shows the high-order coefficients A₄, A₆, As, A₁₀, A₁₂, A₁₄, A₁₆, A₁₈ and A₂₀ applicable to the aspheric surfaces S16, S17, S21 in Embodiment 4.

TABLE 4

surface number

| coefficient | S16 | S17 | S21 |
|---|---|---|---|
| A4 | −1.1464E−01 | 2.7153E−01 | −4.7634E−02 |
| A6 | 2.2587E−01 | 1.1637E−01 | 1.0500E−02 |
| A8 | −4.8393E−03 | 1.4852E−02 | −5.1612E−04 |
| A10 | −1.4819E−02 | −1.5439E−03 | 8.0158E−05 |
| A12 | −6.3860E−03 | −2.1630E−03 | −2.4031E−06 |
| A14 | −2.1304E−03 | −9.0144E−04 | −3.7978E−05 |
| A16 | −5.0213E−04 | −1.9510E−04 | 2.5588E−05 |
| A18 | 0.0000E+00 | 0.0000E+00 | 0.0000E+00 |
| A20 | 0.0000E+00 | 0.0000E+00 | 0.0000E+00 |

### Embodiment 5

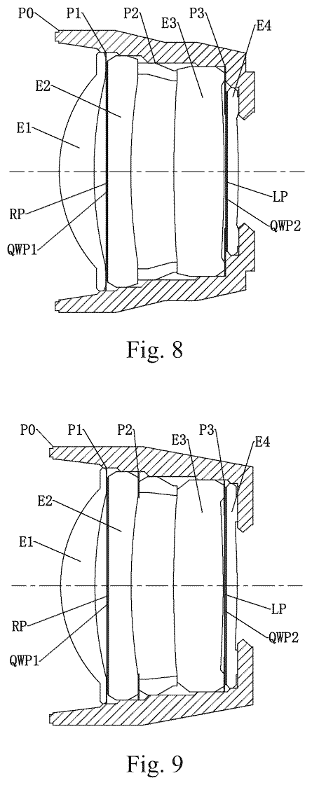

A visual system according to Embodiment 5 of the present disclosure is described below with reference to FIG. 8.

As shown in FIG. 8, the visual system includes a lens barrel P0 and a four-piece lens group and a spacing element group assembled within the lens barrel P0. Here, the four-piece lens group includes, in sequence along an optical axis from a first side (e.g., the side that is close to a human eye) to a second side (e.g., the side that is close to a display): a first lens E1, a reflective polarizing element RP, a first quarter wave plate QWP1, a second lens E2, a third lens E3, a partially reflective element BS (not shown in the drawing), a second quarter wave plate QWP2, a polarizer LP, and a fourth lens E4. The spacing element group includes a first spacing element P1, a second spacing element P2, and a third spacing element P3. The visual system may further include a diaphragm STO provided close to the human eye side. The diaphragm STO may be provided on a first side of the first lens E1.

The structures of the lenses in this embodiment is the same as the structures of the lenses in Embodiment 4, i.e., a table of basic parameters of the visual system in this embodiment is the same as that of Table 3, and a table of aspheric coefficients is the same as that of Table 4. In addition, the spacing elements included in the spacing element group of the visual system in this embodiment are also the same as those included in Embodiment 4, and the difference lies only in that: at least one of the parameters such as a maximal length L of the lens barrel, thicknesses of the spacing elements, inner diameters of the spacing elements and outer diameters of the spacing elements, a spacing EP01 from a first side surface of the lens barrel to a first side surface of the first spacing element along the optical axis, and spacings between the spacing elements along the optical axis, is different from that of Embodiment 4.

### Embodiment 6

A visual system according to Embodiment 6 of the present disclosure is described below with reference to FIG. 9.

As shown in FIG. 9, the visual system includes a lens barrel P0 and a four-piece lens group and a spacing element group assembled within the lens barrel P0. Here, the four-piece lens group includes, in sequence along an optical axis from a first side (e.g., the side that is close to a human eye) to a second side (e.g., the side that is close to a display): a first lens E1, a reflective polarizing element RP, a first quarter wave plate QWP1, a second lens E2, a third lens E3, a partially reflective element BS (not shown in the drawing), a second quarter wave plate QWP2, a polarizer LP, and a fourth lens E4. The spacing element group includes a first spacing element P1, a second spacing element P2, and a third spacing element P3. The visual system may further include a diaphragm STO provided close to the human eye side. The diaphragm STO may be provided on a first side of the first lens E1.

The structures of the lenses in this embodiment is the same as the structures of the lenses in Embodiment 4, i.e., a table of basic parameters of the visual system in this embodiment is the same as that of Table 3, and a table of aspheric coefficients is the same as that of Table 4. In addition, the spacing elements included in the spacing element group of the visual system in this embodiment are also the same as those included in Embodiment 4, and the difference lies only in that: at least one of the parameters such as a maximal length L of the lens barrel, thicknesses of the spacing elements, inner diameters of the spacing elements and outer diameters of the spacing elements, a spacing EP01 from a first side surface of the lens barrel to a first side surface of the first spacing element along the optical axis, and spacings between the spacing elements along the optical axis, is different from that of Embodiment 4.

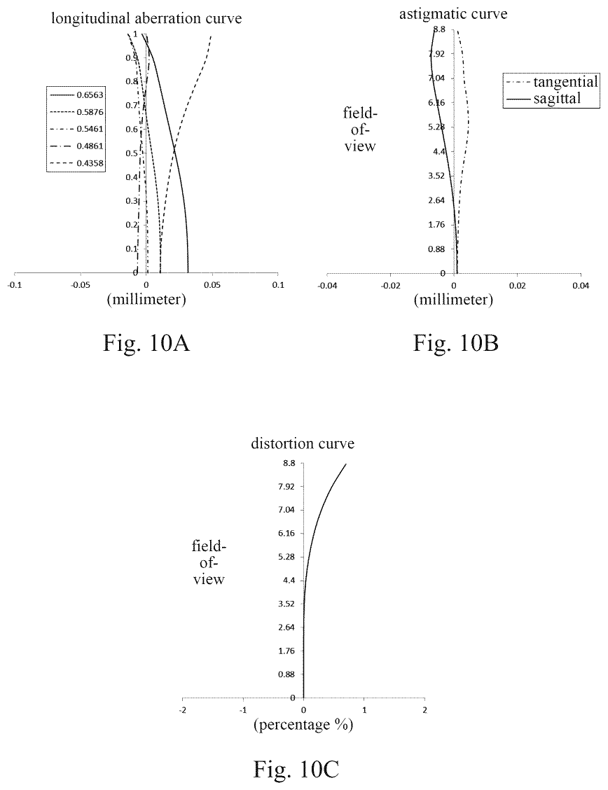

FIG. 10A illustrates a longitudinal aberration curve of the visual system in Embodiment 4, Embodiment 5 or Embodiment 6, representing deviations of focal points at which lights of different wavelengths passing through the visual system converge. FIG. 10B illustrates an astigmatic curve of the visual system in Embodiment 4, Embodiment 5 or Embodiment 6, representing a curvature of a tangential image plane and a curvature of a sagittal image plane corresponding to different fields-of-view. FIG. 10C illustrates a distortion curve of the visual system in Embodiment 4, Embodiment 5 or Embodiment 6, representing amounts of distortion corresponding to different fields-of-view. It can be seen from FIGS. 10A-10C that the visual system given in Embodiment 4, Embodiment 5 or Embodiment 6 can achieve a good imaging quality.

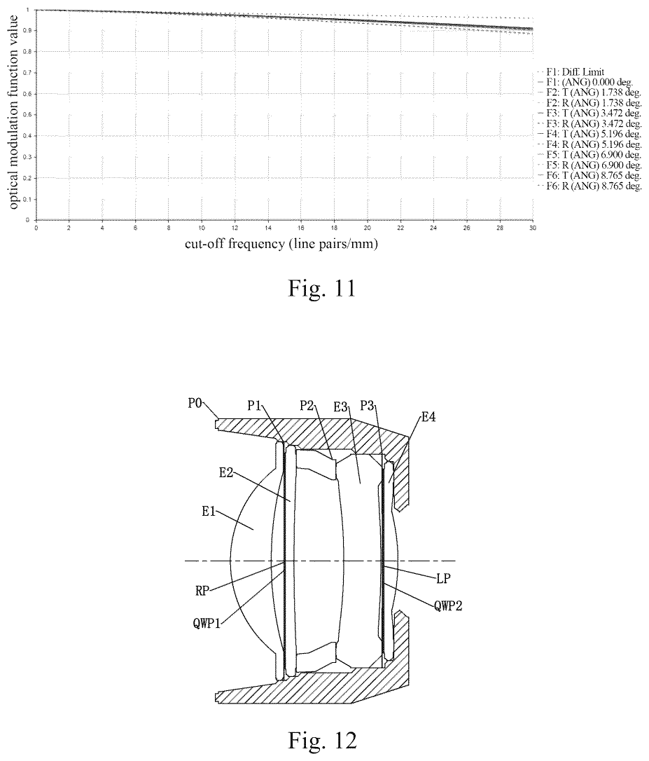

FIG. 11 illustrates an MTF curve of the visual system in Embodiment 4, Embodiment 5 or Embodiment 6. As can be seen from FIG. 11, the visual system in Embodiment 4, Embodiment 5 or Embodiment 6 has good contrast and clear imaging within a spatial frequency of 301p/mm.

### Embodiment 7

A visual system according to Embodiment 7 of the present disclosure is described below with reference to FIG. 12.

As shown in FIG. 12, the visual system includes a lens barrel P0 and a four-piece lens group and a spacing element group assembled within the lens barrel P0. Here, the four-piece lens group includes, in sequence along an optical axis from a first side (e.g., the side that is close to a human eye) to a second side (e.g., the side that is close to a display): a first lens E1, a reflective polarizing element RP, a first quarter wave plate QWP1, a second lens E2, a third lens E3, a partially reflective element BS (not shown in the drawing), a second quarter wave plate QWP2, a polarizer LP, and a fourth lens E4. The spacing element group includes a first spacing element P1, a second spacing element P2, and a third spacing element P3. The visual system may further include a diaphragm STO provided close to the human eye side. The diaphragm STO may be provided on a first side of the first lens E1.

In this embodiment, the first lens E1 has a negative refractive power, a first side surface of the first lens E1 is a convex surface, and a second side surface of the first lens E1 is a concave surface. The second lens E2 has a negative refractive power, a first side surface of the second lens E2 is a planar surface, a second side surface of the second lens E2 is a concave surface. The first quarter wave plate QWP1 and the reflective polarizing element RP are sequentially attached to the first side surface of the second lens E2. The third lens E3 has a negative refractive power, a first side surface of the third lens E3 is a concave surface, and a second side surface of the third lens E3 is a convex surface. The partially reflective element BS is attached to the second side surface of the third lens E3. The fourth lens E4 has a positive refractive power, a first side surface of the fourth lens E4 is a planar surface, and a second side surface of the fourth lens E4 is a convex surface. The polarizer LP and the second quarter wave plate QWP2 are sequentially attached to the first side surface of the fourth lens E4. There may also be an optical element between the fourth lens E4 and an image surface (IMG), which may be an optical filter or a protective glass, or the like.

Table 5 shows a table of basic parameters of the visual system in Embodiment 7. Here, the units of a radius of curvature, a thickness/distance are all millimeters (mm).

TABLE 5

| | | | | | material | | | |
|---|---|---|---|---|---|---|---|---|
| surface | | surface | radius of | thickness/ | refractive | abbe | refraction/ | conic |
| number | optical element | type | curvature | distance | index | number | reflection | coefficient |
| 0 | | | infinite | −100000.0000 | | | refraction | |
| 1 | diaphragm (STO) | | infinite | 20.0000 | | | refraction | |
| 2 | first lens (E1) | spherical | 17.7134 | 6.1820 | 1.502 | 66.05 | refraction | |
| 3 | | spherical | 50.5384 | 1.9380 | | | refraction | |
| 4 | reflective polarizing | | infinite | 0.1100 | 1.502 | 57.00 | refraction | |
| | element (RP) | | | | | | | |
| 5 | first quarter wave | | infinite | 0.1100 | 1.502 | 57.00 | refraction | |
| | plate (QWP1) | | | | | | | |
| 6 | second lens (E2) | | infinite | 1.3000 | 1.855 | 23.79 | refraction | |
| 7 | | spherical | 262.0932 | 7.5369 | | | refraction | |
| 8 | third lens (E3) | aspheric | −100.0000 | 5.6360 | 1.694 | 31.18 | refraction | 0.0000 |
| 9 | partially reflective | aspheric | −124.8604 | −5.6360 | 1.694 | 31.18 | refraction | 0.0000 |
| | element (BS) | | | | | | | |
| 10 | | aspheric | −100.0000 | −7.5369 | | | refraction | 0.0000 |
| 11 | | spherical | 262.0932 | −1.3000 | 1.855 | 23.79 | refraction | |
| 12 | | | infinite | −0.1100 | 1.502 | 57.00 | refraction | |
| 13 | reflective polarizing | | infinite | 0.1100 | 1.502 | 57.00 | refraction | |
| | element (RP) | | | | | | | |
| 14 | second lens (E2) | | infinite | 1.3000 | 1.855 | 23.79 | refraction | |
| 15 | | spherical | 262.0932 | 7.5369 | | | refraction | |
| 16 | third lens (E3) | aspheric | −100.0000 | 5.6360 | 1.694 | 31.18 | refraction | 0.0000 |
| 17 | | aspheric | −124.8604 | 0.2000 | | | refraction | 0.0000 |
| 18 | second quarter wave | | infinite | 0.1100 | 1.502 | 57.00 | refraction | |
| | plate (QWP2) | | | | | | | |
| 19 | polarizer (LP) | | infinite | 0.1500 | 1.502 | 57.00 | refraction | |
| 20 | fourth lens (E4) | | infinite | 2.1171 | 1.620 | 25.60 | refraction | |
| 21 | | aspheric | −32.1789 | 0.7999 | | | refraction | 0.0000 |
| 22 | | | infinite | 0.7100 | 1.519 | 64.17 | refraction | |
| 23 | | | infinite | 0.1000 | | | refraction | |
| 24 | image surface (IMG) | | infinite | 0.0000 | | | refraction | |

In this embodiment, the first side surface S16 and the second side surface S17 of the third lens, and the second side surface S21 of the fourth lens E4 are aspheric surfaces, the surface type x of each aspheric lens may be defined using, but not limited to, the formula (1) given in the above Embodiment 1.

Table 6 shows the high-order coefficients A₄, A₆, As, A₁₀, A₁₂, A₁₄, A₁₆, A₁₈ and A₂₀ applicable to the aspheric surfaces S16, S17, S21 in Embodiment 7.

TABLE 6

surface number

| coefficient | S16 | S17 | S21 |
|---|---|---|---|
| A4 | −2.6123E−02 | 8.6423E−01 | −6.9149E−02 |
| A6 | 1.5122E−01 | 3.7529E−01 | 2.4710E−02 |
| A8 | −1.8531E−01 | 4.6176E−02 | −2.7986E−03 |
| A10 | −9.4805E−02 | −1.6842E−02 | −2.4106E−04 |
| A12 | −4.0745E−02 | −1.9169E−02 | 9.0018E−04 |
| A14 | −1.2081E−02 | −7.7663E−03 | −7.1260E−04 |
| A16 | −1.9036E−03 | −1.4327E−03 | 6.8650E−05 |
| A18 | 0.0000E+00 | 0.0000E+00 | 0.0000E+00 |
| A20 | 0.0000E+00 | 0.0000E+00 | 0.0000E+00 |

### Embodiment 8

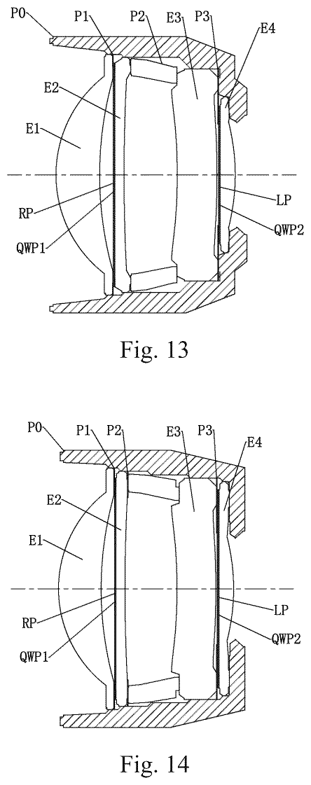

A visual system according to Embodiment 8 of the present disclosure is described below with reference to FIG. 13.

As shown in FIG. 13, the visual system includes a lens barrel P0 and a four-piece lens group and a spacing element group assembled within the lens barrel P0. Here, the four-piece lens group includes, in sequence along an optical axis from a first side (e.g., the side that is close to a human eye) to a second side (e.g., the side that is close to a display): a first lens E1, a reflective polarizing element RP, a first quarter wave plate QWP1, a second lens E2, a third lens E3, a partially reflective element BS (not shown in the drawing), a second quarter wave plate QWP2, a polarizer LP, and a fourth lens E4. The spacing element group includes a first spacing element P1, a second spacing element P2, and a third spacing element P3. The visual system may further include a diaphragm STO provided close to the human eye side. The diaphragm STO may be provided on a first side of the first lens E1.

The structures of the lenses in this embodiment is the same as the structures of the lenses in Embodiment 7, i.e., a table of basic parameters of the visual system in this embodiment is the same as that of Table 5, and a table of aspheric coefficients is the same as that of Table 6. In addition, the spacing elements included in the spacing element group of the visual system in this embodiment are also the same as those included in Embodiment 7, and the difference lies only in that: at least one of the parameters such as a maximal length L of the lens barrel, thicknesses of the spacing elements, inner diameters of the spacing elements and outer diameters of the spacing elements, a spacing EP01 from a first side surface of the lens barrel to a first side surface of the first spacing element along the optical axis, and spacings between the spacing elements along the optical axis, is different from that of Embodiment 7.

### Embodiment 9

A visual system according to Embodiment 9 of the present disclosure is described below with reference to FIG. 14.

As shown in FIG. 14, the visual system includes a lens barrel P0 and a four-piece lens group and a spacing element group assembled within the lens barrel P0. Here, the four-piece lens group includes, in sequence along an optical axis from a first side (e.g., the side that is close to a human eye) to a second side (e.g., the side that is close to a display): a first lens E1, a reflective polarizing element RP, a first quarter wave plate QWP1, a second lens E2, a third lens E3, a partially reflective element BS (not shown in the drawing), a second quarter wave plate QWP2, a polarizer LP, and a fourth lens E4. The spacing element group includes a first spacing element P1, a second spacing element P2, and a third spacing element P3. The visual system may further include a diaphragm STO provided close to the human eye side. The diaphragm STO may be provided on a first side of the first lens E1.

The structures of the lenses in this embodiment is the same as the structures of the lenses in Embodiment 7, i.e., a table of basic parameters of the visual system in this embodiment is the same as that of Table 5, and a table of aspheric coefficients is the same as that of Table 6. In addition, the spacing elements included in the spacing element group of the visual system in this embodiment are also the same as those included in Embodiment 7, and the difference lies only in that: at least one of the parameters such as a maximal length L of the lens barrel, thicknesses of the spacing elements, inner diameters of the spacing elements and outer diameters of the spacing elements, a spacing EP01 from a first side surface of the lens barrel to a first side surface of the first spacing element along the optical axis, and spacings between the spacing elements along the optical axis, is different from that of Embodiment 7.

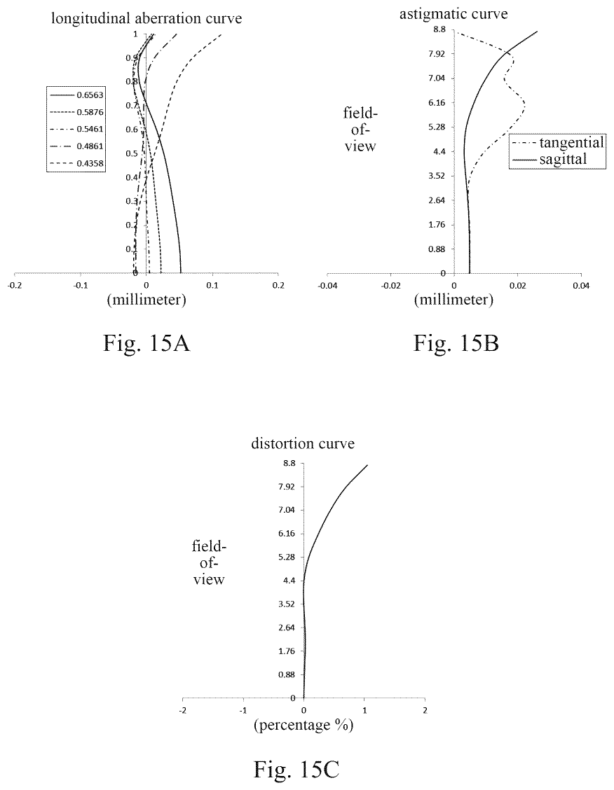

FIG. 15A illustrates a longitudinal aberration curve of the visual system in Embodiment 7, Embodiment 8 or Embodiment 9, representing deviations of focal points at which lights of different wavelengths passing through the visual system converge. FIG. 15B illustrates an astigmatic curve of the visual system in Embodiment 7, Embodiment 8 or Embodiment 9, representing a curvature of a tangential image plane and a curvature of a sagittal image plane corresponding to different fields-of-views. FIG. 15C illustrates a distortion curve of the visual system in Embodiment 7, Embodiment 8 or Embodiment 9, representing amounts of distortion corresponding to different fields-of-views. It can be seen from FIGS. 15A-15C that the visual system given in Embodiment 7, Embodiment 8 or Embodiment 9 can achieve a good imaging quality.

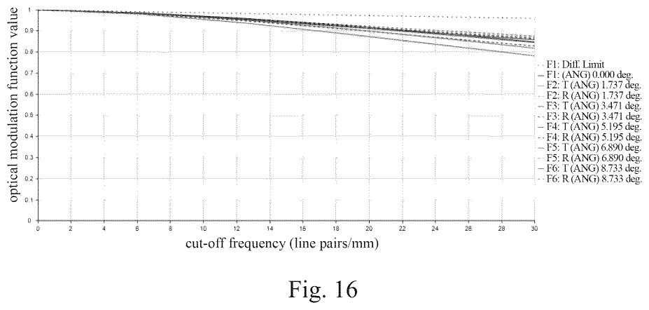

FIG. 16 illustrates an MTF curve of the visual system in Embodiment 7, Embodiment 8 or Embodiment 9. As can be seen from FIG. 16, the visual system in Embodiment 7, Embodiment 8 or Embodiment 9 has good contrast and clear imaging within a spatial frequency of 30 lp/mm.

Table 7 shows some optical parameters of the visual system of each embodiment in Embodiments 1-9, such as an entrance pupil diameter EPD of the visual system, a distance TD from the first side surface of the first lens to the second side surface of the fourth lens on the optical axis, an effective focal length f of the visual system, as well as relevant parameters such as an effective focal length of each lens, a combined focal length. Here, the units of each optical parameter are millimeters (mm).

TABLE 7

| | embodiment | | | | | | | | |
|---|---|---|---|---|---|---|---|---|---|
| parameter | 1 | 2 | 3 | 4 | 5 | 6 | 7 | 8 | 9 |
| f(mm) | 42.00 | 42.00 | 42.00 | 42.00 | 42.00 | 42.00 | 42.00 | 42.00 | 42.00 |
| f1(mm) | 30.25 | 30.25 | 30.25 | 54.54 | 54.54 | 54.54 | 51.08 | 51.08 | 51.08 |
| f2(mm) | −43.96 | −43.96 | −43.96 | −115.25 | −115.25 | −115.25 | −306.52 | −306.52 | −306.52 |
| f3(mm) | 69.52 | 69.52 | 69.52 | 145.02 | 145.02 | 145.02 | −797.62 | −797.62 | −797.62 |
| f4(mm) | −120.79 | −120.79 | −120.79 | 220.00 | 220.00 | 220.00 | 51.91 | 51.91 | 51.91 |
| fz1(mm) | −43.96 | −43.96 | −43.96 | −115.25 | −115.25 | −115.25 | −306.52 | −306.52 | −306.52 |
| fz2(mm) | −120.79 | −120.79 | −120.79 | 220.00 | 220.00 | 220.00 | 51.91 | 51.91 | 51.91 |

Table 8 shows values of some parameters of each embodiment in Embodiments 1-9, such as values of the parameters of dis, dim, D1s, d2s, d2m, D2s, D2m, d3s, d3m, . . . , D0s, D0m, EP01, EP12, EP23, CP1, CP2, CP3, L. Here, the above parameters may be obtained by measuring according to the labeling method shown in FIG. 1, and the units of the parameters listed in Table 8 are all millimeters (mm).

TABLE 8

| | embodiment | | | | | | | | |
|---|---|---|---|---|---|---|---|---|---|
| parameter | 1 | 2 | 3 | 4 | 5 | 6 | 7 | 8 | 9 |
| d1s | 26.965 | 26.425 | 26.965 | 26.184 | 27.036 | 26.271 | 27.014 | 27.193 | 27.193 |
| d1m | 26.965 | 26.425 | 26.965 | 26.184 | 27.036 | 26.271 | 27.014 | 27.193 | 27.193 |
| D1s | 34.126 | 33.126 | 37.434 | 35.153 | 33.153 | 33.553 | 36.063 | 34.128 | 35.117 |
| D1m | 34.126 | 33.126 | 37.434 | 35.153 | 33.153 | 33.553 | 36.063 | 34.128 | 35.117 |
| d2s | 22.502 | 21.616 | 22.973 | 28.931 | 27.060 | 25.063 | 28.578 | 28.578 | 26.504 |
| d2m | 22.502 | 21.616 | 22.973 | 25.692 | 25.193 | 25.063 | 24.619 | 26.025 | 26.504 |
| D2s | 30.680 | 29.951 | 35.834 | 32.153 | 30.153 | 32.553 | 33.470 | 32.788 | 34.117 |
| D2m | 30.680 | 29.951 | 35.834 | 29.443 | 28.018 | 32.553 | 30.678 | 30.648 | 34.117 |
| d3s | 16.465 | 14.081 | 14.876 | 14.333 | 15.960 | 20.269 | 14.445 | 14.447 | 16.209 |
| d3m | 16.465 | 14.081 | 14.876 | 14.333 | 15.960 | 20.269 | 14.445 | 14.447 | 16.209 |
| D3s | 27.234 | 26.124 | 34.234 | 31.153 | 29.153 | 30.153 | 32.310 | 30.058 | 32.117 |
| D3m | 27.234 | 26.124 | 34.234 | 31.153 | 29.153 | 30.153 | 32.310 | 30.058 | 32.117 |
| d0s | 37.209 | 36.209 | 40.517 | 38.236 | 36.236 | 36.636 | 40.036 | 37.221 | 37.215 |
| d0m | 16.520 | 16.520 | 18.176 | 16.520 | 16.520 | 17.411 | 16.962 | 16.962 | 16.827 |
| D0s | 39.690 | 38.690 | 42.997 | 40.716 | 38.716 | 39.116 | 42.516 | 38.640 | 39.695 |
| D0m | 31.184 | 24.891 | 38.184 | 33.852 | 27.705 | 33.852 | 37.512 | 24.608 | 35.207 |
| EP01 | 8.324 | 10.393 | 8.044 | 8.003 | 6.989 | 8.021 | 10.333 | 8.916 | 7.822 |
| CP1 | 0.105 | 0.105 | 0.068 | 0.068 | 0.068 | 0.050 | 0.068 | 0.068 | 0.068 |
| EP12 | 8.374 | 8.128 | 8.374 | 4.415 | 4.415 | 4.415 | 1.870 | 2.445 | 1.870 |
| CP2 | 0.105 | 0.105 | 0.105 | 5.457 | 5.457 | 0.105 | 5.974 | 6.553 | 0.105 |
| EP23 | 6.104 | 6.349 | 6.104 | 6.645 | 6.608 | 11.961 | 6.981 | 5.789 | 12.813 |
| CP3 | 0.105 | 0.105 | 0.105 | 0.068 | 0.105 | 0.105 | 0.068 | 0.105 | 0.105 |
| L | 28.549 | 30.618 | 28.231 | 28.669 | 27.655 | 28.669 | 29.307 | 27.890 | 26.796 |

In summary, in Embodiments 1-9, the visual system respectively satisfies each of the conditional expressions shown in Table 9 below.

TABLE 9

| | embodiment | | | | | | | | |
|---|---|---|---|---|---|---|---|---|---|
| conditional expression | 1 | 2 | 3 | 4 | 5 | 6 | 7 | 8 | 9 |
| EP01/CT1 | 1.07 | 1.33 | 1.03 | 1.65 | 1.44 | 1.66 | 1.67 | 1.44 | 1.27 |
| d0s/R1 | 2.10 | 2.04 | 2.29 | 1.90 | 1.80 | 1.82 | 2.26 | 2.10 | 2.10 |
| (d1s + D1s)/f1 | 2.02 | 1.97 | 2.13 | 1.12 | 1.10 | 1.10 | 1.23 | 1.20 | 1.22 |
| EP12/(CT2 + T23) | 1.15 | 1.12 | 1.15 | 0.48 | 0.48 | 0.48 | 0.21 | 0.28 | 0.21 |
| D1m/D2m | 1.11 | 1.11 | 1.04 | 1.19 | 1.18 | 1.03 | 1.18 | 1.11 | 1.03 |
| (d2s + d2m)/(R4 + R5) | 0.60 | 0.57 | 0.61 | 0.26 | 0.25 | 0.24 | 0.33 | 0.34 | 0.33 |
| d3s/CT3 | 2.35 | 2.01 | 2.13 | 2.05 | 2.28 | 2.90 | 2.56 | 2.56 | 2.88 |
| d0m/(CTQ2 + CTL + CT4) | 6.29 | 6.29 | 6.92 | 9.39 | 9.39 | 9.89 | 7.14 | 7.14 | 7.08 |
| d1m/fz1 | −0.61 | −0.60 | −0.61 | −0.23 | −0.23 | −0.23 | −0.09 | −0.09 | −0.09 |
| (d3m + D3m)/\|fz2\| | 0.36 | 0.33 | 0.41 | 0.21 | 0.21 | 0.23 | 0.90 | 0.86 | 0.93 |
| D3s/R6 | −0.06 | −0.05 | −0.07 | −0.18 | −0.17 | −0.18 | −0.26 | −0.24 | −0.26 |
| (D0s − D0m)/L | 0.30 | 0.45 | 0.17 | 0.24 | 0.40 | 0.18 | 0.17 | 0.50 | 0.17 |
| (CP2 + EP23)/(CT3 + T34) | 0.83 | 0.87 | 0.83 | 1.62 | 1.62 | 1.62 | 2.13 | 2.02 | 2.12 |
| D2s/f2 | −0.70 | −0.68 | −0.82 | −0.28 | −0.26 | −0.28 | −0.11 | −0.11 | −0.11 |
| CP1/CP3 | 1.00 | 1.00 | 0.65 | 1.00 | 0.65 | 0.48 | 1.00 | 0.65 | 0.65 |

The foregoing is only a description for the preferred embodiments of the present disclosure and the applied technical principles. It should be appreciated by those skilled in the art that the inventive scope of the present disclosure is not limited to the technical solution formed by the particular combination of the above technical features. The inventive scope should also cover other technical solutions formed by any combination of the above technical features or equivalent features thereof without departing from the concept of the present disclosure, for example, technical solutions formed by replacing the features disclosed in embodiments of the present disclosure with (but not limited to) technical features with similar functions.

What is claimed is:

1. A visual system, comprising a lens barrel, and a lens group and a spacing element group assembled within the lens barrel, wherein,
the lens group comprises, arranged in sequence along an optical axis from a first side to a second side: a first lens having a positive refractive power, a reflective polarizing element, a first quarter wave plate, a second lens having a negative refractive power, a third lens having a refractive power, a partially reflective element, a second quarter wave plate, a polarizer, and a fourth lens having a refractive power;
the spacing element group comprises: a first spacing element disposed between the first lens and the second lens and against a second side surface of the first lens, a second spacing element disposed between the second lens and the third lens and against a second side surface of the second lens, and a third spacing element disposed between the third lens and the fourth lens and against a second side surface of the third lens;
wherein, a number of lenses having refractive powers in the lens group is four;
a spacing EP01 from a first side surface of the lens barrel to a first side surface of the first spacing element along the optical axis and a center thickness CT1 of the first lens on the optical axis satisfy: 1.0<EP01/CT1<1.7; and
an inner diameter dos of the first side surface of the lens barrel and a radius of curvature R1 of a first side surface of the first lens satisfy: 1.75<d0s/R1<2.3.

2. The visual system according to claim 1, wherein a spacing EP12 from a second side surface of the first spacing element to a first side surface of the second spacing element along the optical axis, a center thickness CT2 of the second lens on the optical axis, and an axial distance T23 from the second side surface of the second lens to a first side surface of the third lens satisfy: 0.2<EP12/(CT2+T23)<1.2.

3. The visual system according to claim 1, wherein an outer diameter D1m of a second side surface of the first spacing element and an outer diameter D2m of a second side surface of the second spacing element satisfy: 1.0<D1m/D2m<1.2.

4. The visual system according to claim 1, wherein an inner diameter d2s of a first side surface of the second spacing element, an inner diameter d2m of a second side surface of the second spacing element, a radius of curvature R4 of the second side surface of the second lens, and a radius of curvature R5 of a first side surface of the third lens satisfy: 0.2<(d2s+d2m)/(R4+R5)<0.65.

5. The visual system according to claim 1, wherein an inner diameter d3s of a first side surface of the third spacing element and a center thickness CT3 of the third lens on the optical axis satisfy: 2.0<d3s/CT3<2.95.

6. The visual system according to claim 1, wherein an inner diameter d0m of a second side surface of the lens barrel, a center thickness CTQ2 of the second quarter wave plate on the optical axis, a center thickness CTL of the polarizer on the optical axis, and a center thickness CT4 of the fourth lens on the optical axis satisfy: 6.2<d0m/(CTQ2+CTL+CT4)<9.9.

7. The visual system according to claim 1, wherein an inner diameter dim of a second side surface of the first spacing element, and a combined focal length fz1 of the reflective polarizing element, the first quarter wave plate and the second lens, satisfy:
−0.65<d1m/fz1<−0.05.

8. The visual system according to claim 1, wherein an inner diameter d3m of a second side surface of the third spacing element, an outer diameter D3m of the second side surface of the third spacing element, and a combined focal length fz2 of the second quarter wave plate, the polarizer and the fourth lens satisfy: 0.2<(d3m+D3m)/|fz2|<1.0.

9. The visual system according to claim 1, wherein an outer diameter D3s of a first side surface of the third spacing element and a radius of curvature R6 of the second side surface of the third lens satisfy: −0.3<D3s/R6<0.

10. The visual system according to claim 1, wherein an outer diameter D0s of the first side surface of the lens barrel, an outer diameter D0m of a second side surface of the lens barrel, and a spacing L from the first side surface of the lens barrel to the second side surface of the lens barrel along the optical axis satisfy: 0.15<(D0s−D0m)/L<0.55.

11. The visual system according to claim 1, wherein a maximal thickness CP2 of the second spacing element, a spacing EP23 from the second side surface of the second spacing element to the first side surface of the third spacing element along the optical axis, the center thickness CT3 of the third lens on the optical axis, and an axial distance T34 from the second side surface of the third lens to a first side surface of the fourth lens satisfy: 0.8<(CP2+EP23)/(CT3+T34)<2.2.

12. The visual system according to claim 1, wherein an outer diameter D2s of the first side surface of the second spacing element and an effective focal length f2 of the second lens satisfy: −0.85<D2s/f2<−0.1.

13. The visual system according to claim 1, wherein a maximal thickness CP1 of the first spacing element and a maximal thickness CP3 of the third spacing element satisfy: 0.4<CP1/CP3<1.05.

14. The visual system according to claim 1, wherein an inner diameter d1s of the first side surface of the first spacing element, an outer diameter D1s of the first side surface of the first spacing element, and an effective focal length f1 of the first lens satisfy: 1.05<(d1s+D1s)/f1<2.2.
